(19) United States
(12) Patent Application Publication
(10) Pub. No.: US 2005/0233265 A1
(43) Pub. Date: Oct. 20, 2005

(54) Photosensitive thermal development recording material, its case, and developing method and production process of photosensitive thermal recording material

(75) Inventor: Yasunori Ohta, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/071,237

(22) Filed: Mar. 4, 2005

(30) Foreign Application Priority Data
Mar. 4, 2004 (JP) P.2004-060787

(51) Int. Cl. G03C 8/00

(52) U.S. Cl. 430/502

(57) ABSTRACT

A case of a photosensitive thermal development recording material for housing a photosensitive thermal development recording material has a support and an image forming layer containing a photosensitive silver halide, a non-photosensitive organic silver salt, a reducing agent and a binder on at least one surface of the support, wherein the case is provided with a main body having a housing section for housing the photosensitive thermal development recording material, at least a surface of the case being made of a light-shielding material, and the housing section is provided with a sensitizing member.

### BACKGROUND OF THE INVENTION

1. Technical Field of the Invention

The present invention relates to a photosensitive thermal development recording material for forming a latent image upon irradiation with X-rays, its case, and developing method and production process of a photosensitive thermal development recording material.

2. Background of the Invention

In recent years, thermal development equipments and thermal development recording equipments by a dry system, which are free from wet processing, have been proposed. In such thermal development equipments or thermal development recording equipments, photosensitive and/or heat-sensitive recording materials (photosensitive heat-sensitive development materials) or film-like recording materials containing a photosensitive thermal development recording material (hereinafter referred to as “photosensitive thermal development recording materials”) are used as a recording medium.

Examples of such a dry system include an X-ray equipment which is used in medical facilities such as hospitals. The X-ray equipment is constructed such that a photosensitive thermal development recording material is held in a cassette and irradiated with X-rays from an X-ray tube, thereby transmitting the X-rays into an object to form a latent image on the photosensitive thermal development recording material (for example, see Patent Documents JP-A-4-256946 and JP-A-60-153000).

If a photosensitive thermal development recording material is handled in a bright room, it is sensitized to light. Accordingly, it is necessary to perform works to set the photosensitive thermal development recording material in a cassette in a dark room before X-ray capturing. However, it is demanded to avoid works in a dark room as far as possible. In particular, in facilities where the X-ray capturing is not so frequently performed, such as small-scale hospitals, it is required that dark room facilities be not provided as far as possible from the standpoint of effectively utilizing the place.

Under these circumstances, the invention has been made.

### SUMMARY OF THE INVENTION

An object of the invention is to provide a photosensitive thermal development recording material which does not require works in a dark room and can be easily handled, its case and developing method and production process of a photosensitive thermal development recording material.

The foregoing object of the invention is achieved by a case of a photosensitive thermal development recording material for housing a photosensitive thermal development recording material having a support and an image forming layer containing a photosensitive silver halide, a non-photosensitive organic silver salt, a reducing agent and a binder on at least one surface of the support, wherein the case is provided with a main body having a housing section for housing the photosensitive thermal development recording material, at least a surface of the case being made of a light-shielding material; and the housing section is provided with a sensitizing member.

This case of a photosensitive thermal development recording material is provided with a main body made of a light-shielding material. By housing a photosensitive thermal development recording material in the case, it is possible to prevent a phenomenon that the photosensitive thermal development recording material is sensitized to light in a bright room from occurring. Also, since fingers do not directly touch the photosensitive thermal development recording material, it is possible to prevent a phenomenon that stains such as fingerprints adhere onto the photosensitive thermal development recording material from occurring. Moreover, since a sensitizing member is installed in the case, it is possible to perform X-ray capturing in the state that the photosensitive thermal development recording material is housed in the case. Thus, in performing capturing in an X-ray equipment, a cassette for holding a photosensitive thermal development recording material becomes unnecessary.

In the foregoing case of a photosensitive thermal development recording material, it is preferable that the sensitizing member is adhered onto an inner surface of the housing section opposing to the image forming layer of the photosensitive thermal development recording material.

According to this construction, in inserting the recording material into the case or taking out the recording material from the case, it is possible to prevent a phenomenon that the sensitizing member moves within the housing section to cause twisting or wrinkles from occurring.

In the foregoing case of a photosensitive thermal development recording material, it is preferable that the housing section is partitioned into a pair of pocket portions by a partitioning portion; the photosensitive thermal development recording material is held in one of the pair of pocket portions; the sensitizing member is held in the other pocket portion; and a window portion is opened in a place corresponding to a portion for forming a latent image in the partitioning portion.

According to this case of a photosensitive thermal development recording material, by exchanging the photosensitive thermal development recording material held in one of the pair of pocket portions in every X-ray capturing to reuse the relatively expensive sensitizing member held in the other pocket portion, it is possible to repeatedly use (recycle) the case.

It is preferable that the foregoing light-shield material cuts a color light having a wavelength of not longer than 500 nm.

According to this construction, by shielding the color light having a wavelength of not longer than 500 nm and using a transparent or translucent material as a material having a photosensitive filtering function, it is possible to visibly confirm the state of the recording material housed in the case from the outside of the case. In addition, “color light” as referred to herein means a visible light, which has a wavelength of about from 400 nm to 700 nm. For this reason, in directly loading the case in a thermal development equipment and performing thermal development, it is possible to confirm the development state without taking out the recording material from the case, and therefore, such is convenient for use.

Further, the foregoing object of the invention is achieved by a cassette for holding the foregoing case of a photosensitive thermal development recording material and capable of being loaded in an X-ray equipment for forming a latent image upon irradiation of the foregoing photosensitive thermal development recording material with X-rays.

According to this cassette, it is possible to strengthen the degree of adhesion between the recording material housed within the foregoing case and the sensitizing member. Also, it is not necessary to install a sensitizing member within the cassette as seen in the related art, and therefore, maintenance of the cassette such as cleaning becomes easy.

Moreover, the foregoing object of the invention is achieved by a method for developing a photosensitive thermal development recording material having a support and an image forming layer containing a photosensitive silver halide, a non-photosensitive organic silver salt, a reducing agent and a binder on at least one surface of the support, which comprises housing the photosensitive thermal development recording material in a case at least a surface of which is made of a light-shielding material; irradiating the photosensitive thermal development recording material with X-rays in a state that the case is provided with a sensitizing member; and then thermally developing the photosensitive thermal development recording material in a state that the photosensitive thermal development recording material is housed in the case to visualize a latent image.

According to this developing method, since the case is made of a light-shielding material, it is possible to handle the photosensitive thermal development recording material housed in this case in a bright room. Also, since the case is provided with a sensitizing member, a cassette provided with a screen functioning as a sensitizing member as seen in the related art is not necessary. By performing thermal development in the state that the photosensitive thermal development recording material is housed in the case, it is possible to omit works for loading the photosensitive thermal development recording material in a cassette. Accordingly, such is convenient for use especially in the circumference where the number of X-ray capturing is small (for example, small-scale medical spots such as those of a doctor in private practice).

Still further, the foregoing object of the invention is achieved by a photosensitive thermal development recording material comprising a support and an image forming layer containing a photosensitive silver halide, a non-photosensitive organic silver salt, a reducing agent and a binder on at least one surface of the support, a sensitizing layer being formed on a surface of the image forming layer and a surface of the sensitizing layer being covered by a light-shielding layer.

Since this photosensitive thermal development recording material is covered by a light-shielding layer, it is possible to handle the photosensitive thermal development recording material in a bright room even in that state it is not housed in a case made of a light-shielding material or a cassette of the related art. Accordingly, works in a dark room are not required, and therefore, such is convenient for use. Also, at the time of X-ray capturing, it is possible to irradiate this photosensitive thermal development recording material with X-rays; at the time of thermal development, by loading this recording material in a thermal development equipment as it is, it is possible to perform thermal development processing; and after the thermal development, by peeling a light-shielding layer and a sensitizing layer, it is possible to obtain a developed recording material.

Even further, the foregoing object of the invention is achieved by a process for producing a photosensitive thermal development recording material having a support and an image forming layer containing a photosensitive silver halide, a non-photosensitive organic silver salt, a reducing agent and a binder on at least one surface of the support, which comprises forming the image forming layer on the fed support; laminating a sensitizing layer on the surface of the image forming layer; laminating a light-shielding layer on the surface of the sensitizing layer; and then cutting the support.

According to this production process, since the single production step includes a step for forming an image forming layer on a support, a step for laminating a sensitizing layer on a surface of the image forming layer, a step for laminating a light-shielding layer on a surface of the sensitizing layer, and a step for cutting the support, it is possible to efficiently produce a photosensitive thermal development recording material capable of being handled in a bright room.

According to the invention, it is possible to provide a photosensitive thermal development recording material which does not require works in a dark room and can be easily handled, its case and developing method and production process of a photosensitive thermal development recording material.

### BRIEF DESCRIPTION OF THE DRAWINGS

FIG. 1 a view to explain the first embodiment of a case of a photosensitive thermal development recording material according to the invention.

FIG. 2 is a cross-sectional view to show aother embodiment of the case of the first embodiment.

FIG. 3 is an overall perspective view to show a cassette according to the invention.

FIG. 4 is a cross-sectional view of a photosensitive thermal development recording material according to the invention.

FIG. 5 is a view to conceptually explain the production step of the photosensitive thermal development recording material of FIG. 4.

FIG. 6 is a view to conceptually explain the step of performing of X-ray capturing a case of a recording material.

FIG. 7 is an perspective view to show the second embodiment of a case of a photosensitive thermal development recording material according to the invention.

FIG. 8 is a cross-sectional view to show the state that a photosensitive thermal development recording material and a sensitizing member are housed in the case illustrated in FIG. 7.

FIG. 9 is a view to schematically show the steps of performing X-ray capturing and thermal development using the case of a photosensitive thermal development recording material illustrated in FIGS. 7 and 8.

FIG. 10 is a view to show the fourth embodiment of a case of a photosensitive thermal development recording material according to the invention.

FIG. 11 is an XI-XI line cross-sectional view of the case of a photosensitive thermal development recording material illustrated in FIG. 10.

FIG. 12 is a cross-sectional view to show another embodiment of a case of a photosensitive thermal development recording material according to the invention.

FIG. 13 is a view to conceptually explain the production step of the photosensitive thermal development recording material of FIG. 12.

### DETAILED DESCRIPTION OF THE INVENTION

Preferred embodiments of the photosensitive thermal development recording material, its case and developing method and production method of a photosensitive thermal development recording material according to the invention will be described below with reference to the drawings.

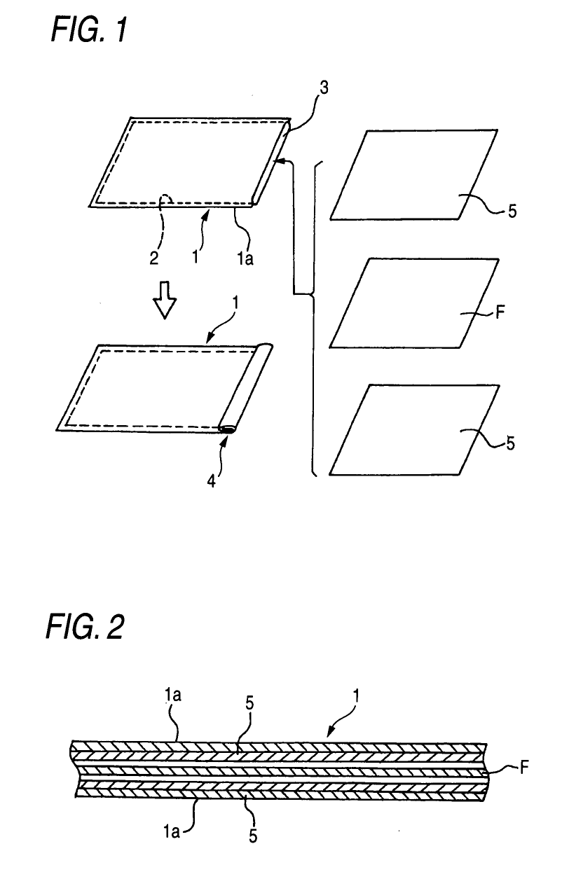

FIG. 1 is a view to explain the first embodiment of a case of a photosensitive thermal development recording material according to the invention. A case 1 is one housing a photosensitive thermal development recording material (hereinafter often referred to as “recording material”) F in which a latent image is formed upon irradiation with X-rays.

The recording material F is provided with an image forming layer containing a photosensitive silver halide, a non-photosensitive organic silver salt, a reducing agent and a binder on at least one surface of a support, in which a latent image is previously formed on the image forming layer upon irradiation with X-rays, and the recording material F is subjected to thermal development to visualize the latent image on the image forming layer. The image forming layer will be hereunder often referred to as “photosensitive layer”.

The case 1 has a main body 1a and a housing section 2 for housing the recording material, which is provided inside the main body 1a. The main body 1a is a closed-end longitudinal bag-like member and constructed such that the recording material F can be inserted from an opening 3 formed in one end portion thereof. The case 1 is a member in which at least the surface of the main body 1a is made of a light-shielding material. Examples of the light-shielding material which can be used include metals such as an aluminum foil, black resins, and composite members thereof.

In the housing section 2 of the case 1, the recording material F and sensitizing members 5 to be disposed on the both surfaces of the recording material F are inserted inside the housing section 2. After housing the recording material F and the sensitizing members 5 in the housing section 2, by folding an end side in the side where the opening 3 is formed in a prescribed width to form a folded portion 4, the opening 3 is shielded, whereby the light-shielding properties inside the housing section 2 are ensured. In taking out the recording material F from the case 1, by opening the folded portion 4, it is possible to take out the recording material F from the opening 3. Incidentally, in the case 1 of this embodiment, the folded portion 4 is not limited, but for example, a chuck portion capable of opening and closing the end side in the side where the opening 3 is formed by means of a chuck may be provided.

The case 1 is not limited to the construction in which the sensitizing members 5 are housed in the housing section 2 as in this embodiment. FIG. 2 is a cross-sectional view to show other embodiment of the case of this embodiment. As illustrated in FIG. 2, a construction in which the sensitizing members 5 are adhered onto an inner surface of the housing section 2 may be employed. According to this construction, in inserting or taking out the recording material F, it is possible to prevent a phenomenon that the sensitizing members 5 move within the housing section 2 to cause twisting or wrinkles from occurring.

This case 1 is provided with the main body 1a made of a light-shielding material, and by housing the recording material F in this case 1, it is possible to prevent a phenomenon that the recording material F is sensitized to light in a bright room from occurring. Also, since fingers do not directly touch the recording material F, it is possible to prevent a phenomenon that stains such as fingerprints adhere onto the recording material F from occurring. Moreover, since the sensitizing members 5 are installed in the case 1, it is possible to perform X-ray capturing in the state that the recording material F is housed in the case 1. Thus, in performing capturing in an X-ray equipment, it is not necessary to provide a screen having the same function as the sensitizing members in the side of a cassette for holding the recording material.

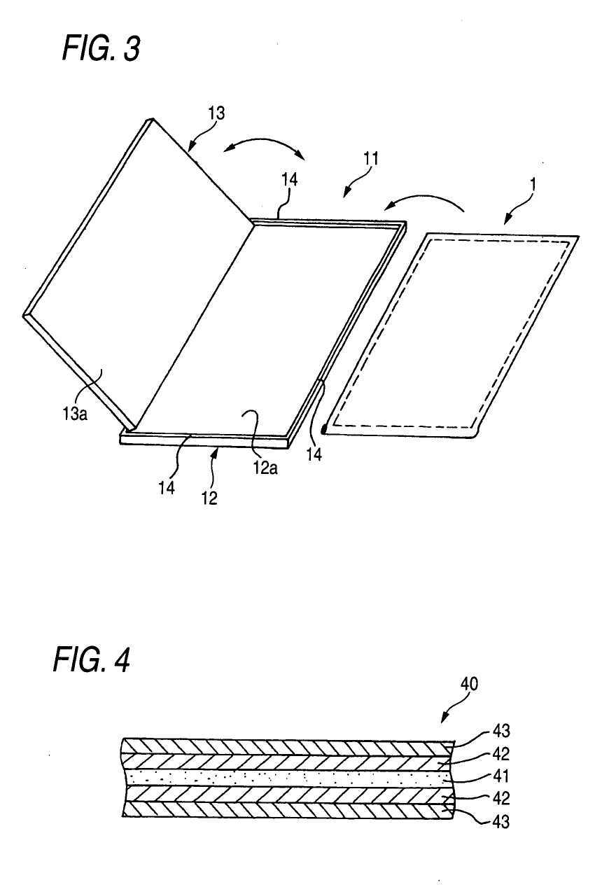

FIG. 3 is an overall perspective view to show a cassette according to the invention. As illustrated in FIG. 3, a cassette 11 houses and holds the recording material F therein and is loaded in an X-ray equipment, and the thus held recording material F is irradiated with X-rays.

As illustrated in FIG. 3, the cassette 11 is provided with a main body 12 having a quadrangular bottom face 12a which comes into face contact with the recording material F and a rib 14 vertically provided so as to surround a peripheral portion of the bottom face 12a. Also, the cassette 11 can dispose the recording material F in the site surrounded by the rib 14 of this main body 12 and is provided with a lid 13 capable of opening and shielding this site. In the case of setting the recording material F in the cassette 11, the lid 13 is opened, the recording material F is disposed in the main body 12, and the lid 13 is then closed.

By housing the case 1 in the main body 12 and closing the lid 13, it is possible to strengthen the degree of adhesion between the recording material housed within the case 1 and the sensitizing members.

Since the recording material F is provided with the sensitizing members 5, it is not necessary to provide a screen, etc. as seen in the related art in the bottom face 12a or an inner surface 13a of the lid 13 (the surface in the side of the bottom face 12a when the lid 13 is closed). For this reason, maintenance of the cassette such as cleaning becomes easy.

Next, the photosensitive thermal development recording material according to the invention will be described below with reference to the drawings.

FIG. 4 is a cross-sectional view of a photosensitive thermal development recording material according to the invention. As illustrated in FIG. 4, a recording material 40 has a support 41 and photosensitive layers 42 provided on the both surfaces of the support 41.

Also, in the recording material 40, a sensitizing layer 43 is provided on each of the surfaces of the foregoing photosensitive layers 42. Incidentally, the recording material 40 may be constructed such that the photosensitive layer 42 is provided only on one surface of the support 41. Also, the recording material 40 may be constructed such that the sensitizing layer 43 is provided on the surface of only one photosensitive layer 42 of the photosensitive layers 42 provided on the both surfaces of the support 41.

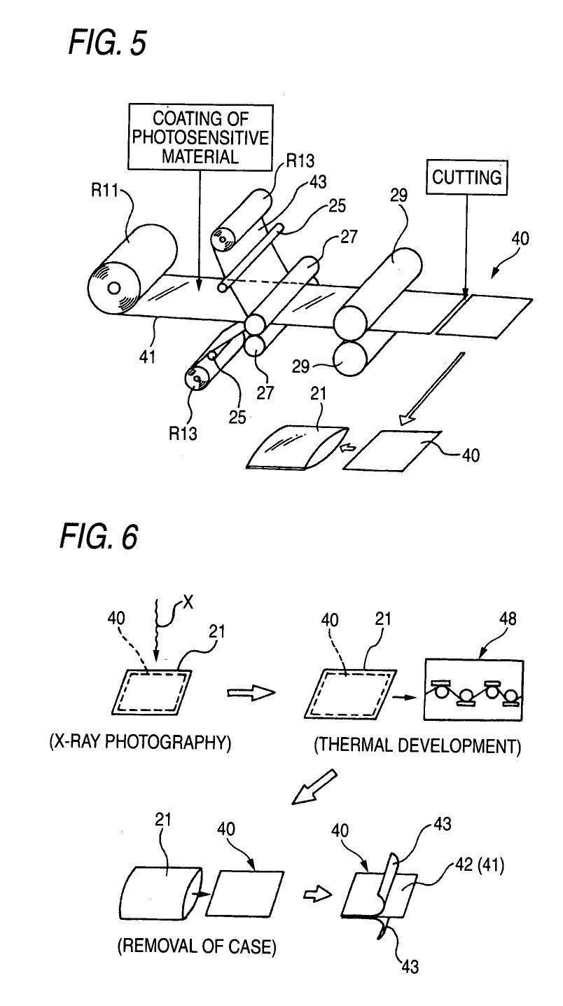

The production step of the photosensitive thermal development recording material as illustrated in FIG. 4 will be described below. FIG. 5 is a view to conceptually explain the production step of the photosensitive thermal development recording material of FIG. 4.

As illustrated in FIG. 5, the support 41 is wound out from a support master roll R11. Photosensitive materials are coated on the both surfaces of the support 41 as wound out to form the photosensitive layers 42. Sensitizing material master rolls R13 are disposed in the upward and downward portions of a traveling passage of the support 41 having the photosensitive layers 42 formed thereon. Sensitizing materials (sensitizing layers 43) as wound out from the sensitizing material master rolls R13 are pressed on the both surfaces of the support 41 by a pair of adsorbing rollers 27 while being guided by guide rollers 25 and heat sealed by a pair of heating pressure rollers 29 disposed in the downstream side in the traveling direction. The support 41 in which the sensitizing layers 43 have been thus provided on the both front and rear surfaces thereof is cut into a prescribed dimension in the downstream side of the heating pressure rolls 29 to prepare the recording material 40.

In the production process of this recording material 40, a pair of the sensitizing layers 43 are laminated on the support 41 immediately after coating the photosensitive material thereon from the front and rear surfaces, and after the lamination, the support 41, the photosensitive layers 42, and the sensitizing layers 43 are cut.

The recording material 40 obtained by cutting is housed in the case 21. In the case 21, at least the outside thereof is made of a light-shielding material, and its construction is basically identical with that of the case 1 explained in FIG. 1 but is different in the point that the sensitizing material 5 is not provided in the main body.

A step of performing X-ray capturing of the case in which the recording material obtained in the production step of the recording material illustrated in FIG. 5 has been housed will be described below. FIG. 6 is a view to conceptually explain the step of performing X-ray capturing of a case of a recording material.

The recording material 40 housed in the case 21 is irradiated with X-rays X to form a latent image on the photosensitive layer of the recording material 40. After the irradiation with X-rays, the case 21 having the recording material 40 housed therein is thermally developed by a thermal development equipment 48. After the thermal development, the recording material 40 is taken out from the case 21, and the sensitizing layers 43 are peeled away from the photosensitive layer 42 (support 41).

The photosensitive thermal development recording material 40 illustrated in FIG. 4 is constructed such that the sensitizing layer 43 is provided on the surface of the photosensitive layer 42, and in the same production step, the sensitizing layer 43 may be laminated on the surface of the photosensitive layer 42 while forming the photosensitive layer 42 on the support 41, and therefore, its production is easy. Also, since the photosensitive thermal development recording material 40 is provided with the sensitizing layers 43, it is not necessary to install a screen functioning as a sensitizing member within the cassette to be provided in an X-ray equipment as seen in the related art.

Also, as illustrated in FIG. 5, the production process of the photosensitive thermal development recording material according to the invention includes a step for forming the photosensitive layer 42 on the support 41, a step for laminating the sensitizing layer 43 on the surface of the photosensitive layer 42, and a step for cutting the support 41 in a single production step, and therefore, it is possible to efficiently produce a photosensitive thermal development recording material.

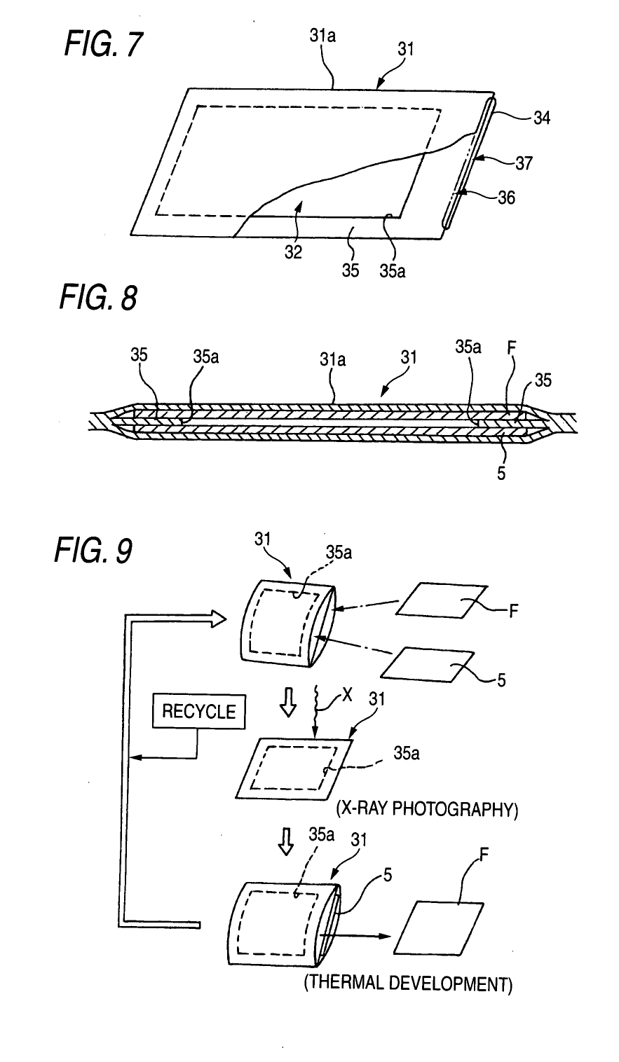

FIG. 7 is a perspective view to show the second embodiment of a case of a photosensitive thermal development recording material according to the invention.

As illustrated in FIG. 7, a case 31 has a main body 31a and a housing section 32 for housing a recording material (for example, the recording material F of FIG. 1 can be used), which is provided inside the main body 31a. The main body 31a is a closed-end longitudinal bag-like member and constructed such that the recording material F can be inserted from an opening 34 formed in one end portion thereof. The case 31 is a member in which at least the surface of the main body 31a is made of a light-shielding material. As the light-shielding material, those described above can be used.

The main body 31a of the case 31 of this embodiment is provided with a partitioning portion 35 as integrally formed with the inner periphery of the housing section 32 so as to partition the housing section 32 into two sections. The opening 34 is also divided into two sections of an upper-sided opening 36 and a lower-sided opening 37 by this partitioning portion 35.

In other words, in the housing section 32, the spaces partitioned by the partitioning portion 35 become a pair of pocket portions, and the pair of pocket portions are respectively communicated into the outside of the case 31 via the respectively divided upper-sided opening 36 and lower-sided opening 37.

The housing section 32 of this embodiment is constructed such that a photosensitive thermal development recording material (for example, the recording material F of FIG. 1 can be used; hereinafter omitted) can be held in one of the pair of pocket portions, whereas the sensitizing member 5 can be held in the other pocket portion.

In the partitioning portion 35, a window portion 35a having a dimension corresponding to the type of the recording material F and the size and position of a latent image to be formed in this recording material upon irradiation with X-rays is formed.

The number of pocket portions to be partitioned inside the housing section 32 of the case 31 is not limited to two as in this embodiment but may be partitioned into three or more by the partitioning portion 35.

FIG. 8 is a cross-sectional view to show the state that a photosensitive thermal development recording material and a sensitizing member are housed in the case illustrated in FIG. 7. As illustrated in FIGS. 7 and 8, the recording material F and the sensitizing material 5 are held in the partitioned state by the partitioning portion 35 in the housing section 32 of the case 31. Also, the case 31 is constructed such that the window portion 35a is formed in the central portion of the partitioning portion 35 and that in a place opened by this window portion 35a, the recording material F and the sensitizing member 5 are exposed each other and brought into direct contact with each other. For this reason, when the case 31 is irradiated with X-rays, in the place opened by the window portion 35a in the recording material F, a latent image is formed while strengthening the reaction of the photosensitive layer by the sensitizing member 5.

FIG. 9 is a view to schematically show the steps of performing X-ray capturing and thermal development using the case of a photosensitive thermal development recording material illustrated in FIGS. 7 and 8. The recording material F is housed in one of the pair of pockets of the case 31, and the sensitizing member 5 is housed in the other pocket. A latent image is formed on the photosensitive layer of the recording material F upon irradiation of the case 31 having the recording material F and the sensitizing member 5 housed therein with the X-rays X. In X-ray capturing, X-rays may be irradiated in the state that the case 31 is housed in and held by a cassette (see FIG. 3). Next, the case 31 is directly loaded in a thermal development equipment and subjected to thermal development. After the thermal development, the recording material F is taken out from the case 31. At this time, by employing a construction that the sensitizing member 5 can be used in the prescribed number of times, a fresh recording material F is housed in the state that the sensitizing member 5 is housed in the pocket portion as it is, whereby the case 31 can be repeatedly used (recycled).

Next, the third embodiment of the photosensitive thermal development recording material according to the invention will be described below. In the embodiment as described below, with respect to the members, etc. having equivalent constructions and actions to those described previously, their explanations will be simplified or omitted. A basic construction of the case of this embodiment is the same as the construction of the case illustrated in FIG. 1 but is different in the point that the main body is constructed of a material having a photosensitive filtering function for the purpose of shielding photosensitive wavelengths as the light-shielding material. As the material having a photosensitive filtering function, for example, light-shielding materials capable of shielding color light having a wavelength of not longer than 500 nm can be used.

In this embodiment, by using a light-shielding material capable of shielding color light having a wavelength of not longer than 500 nm, it is possible to visibly confirm the state of the recording material housed in the case from the outside of the case. For this reason, in directly loading the case in a thermal development equipment and performing thermal development, it is possible to confirm the development state without taking out the recording material from the case, and therefore, such is convenient for use.

Next, a sensitizing member of the invention such as fluorescent sensitizing paper, radiation sensitizing screen will be described below. The sensitizing member has a basic structure comprising a support having a fluorescent layer formed on one surface thereof. The fluorescent layer is a layer having a fluorescent dispersed in a binder. Incidentally, on the surface of the fluorescent layer in the side opposing to the surface on which the support is formed (i.e., the surface in the side not facing the support), a transparent protective film is generally provided, thereby protecting the fluorescent layer from chemical modifications or physical impacts.

In the invention, preferred examples of the fluorescent include as follows.

That is, examples include tungstate based fluorescents (for example, CaWO₄, MgWO₄, and CaWO₄:Pb); terbium activated rare earth element acid sulfide based fluorescents (for example, Y₂O₂S:Tb, Gd₂O₂S:Tb, La₂O₂S:Tb, (Y,Gd)₂O₂S:Tb, and (Y,Gd)O₂S:Tb,Tm); terbium activated rare earth element phosphate based fluorescents (for example, YPO₄:Tb, GdPO₄:Tb, and LaPO₄:Tb); terbium activated rare earth element oxyhalide based fluorescents (for example, LaOBr:Tb, LaOBr:Tb,Tm, LaOCl:Ta, LaOCl:Tb,Tm, LaOBr:Tb, GdOBr:Tb, and GdOCl:Tb); thulium activated rare earth element oxyhalide fluorescents (for example, LaOBr:Tm and LaOCl:Tm); barium sulfate based fluorescents (for example, BaSO₄:Pb, BaSO₄:Eu²⁺, and (Ba,Sr)SO₄:Eu²⁺); divalent europium activated alkaline earth metal phosphate based fluorescents (for example, (Ba₂PO₄)₂:Eu²⁺); divalent europium activated alkaline earth metal fluorohalide based fluorescents (for example, BaFCl:Eu² BaFBr:Eu²⁺, BaFCl:Eu²⁺,Tb, BaFBr:Eu²⁺,Tb, BaF₂.BaCl.KCl:Eu²⁺, and (Ba,Mg)F₂.BaCl.KCl:Eu²⁺); iodide based fluorescents (for example, CsI:Na, CsI:Tl, NaI, and KI:Tl); sulfide based fluorescents (for example, ZnS:Ag(Zn,Cd)S:Ag, (Zn,Cd)S:Cu, and (Zn,Cd)S:Cu,Al); hafnium phosphate based fluorescents (for example HfP₂O₇:Cu); and YTaO₄ and ones to which a varied activator is added as an emission center. However, the fluorescent which is used in the invention is not limited thereto, and any fluorescent capable of revealing emission in visible or near ultraviolet regions upon irradiation with radiations can be used.

In the sensitizing member to be used in the invention, it is preferable that the fluorescent is charged by the inclined particle size structure. In particular, it is preferable that fluorescent particles having a large particle size are coated in the surface protective layer side, whereas fluorescent particles having a small particle size are coated in the support side and that those having a small particle size have a particle size in the range of from 0.5 to 2.0 μm, whereas those having a large particle size have a particle size in the range of from 10 to 30 μm.

Also, since the sensitizing member is developed at a temperature of from 80 to 250° C., it is preferable that not only PET (polyethylene terephthalate) as the support is of a heat resistant grade type, but also the fluorescent is molded with a transparent silicone resin.

(Combination with Ultraviolet Fluorescent Screen)

As the image forming method using the photosensitive thermal development recording material of the invention, it is possible to employ a method of forming an image by combining a fluorescent preferably having a principal peak at not longer than 400 nm. More preferably, a method of forming an image by combining a fluorescent having a principal peak at not longer than 380 nm is suitable. Any of double-sided photosensitive materials and single-sided photosensitive materials can be used as an assembly. As the screen having a principal emission peak at not longer than 400 nm, screens described in JP-A-6-11804 and WO 93/01521 are used, but it should not be construed that the invention is limited thereto. As technologies of cross-over cutting (double-sided photosensitive material) and anti-halation (single-sided photosensitive material) of ultraviolet rays, a technology described in JP-A-8-76307 can be employed. As ultraviolet absorbing dyes, dyes described in Japanese Patent Application No. 2000-320809 are especially preferable.

Next, the fourth embodiment of a case of photosensitive thermal development recording material according to the invention will be described below.

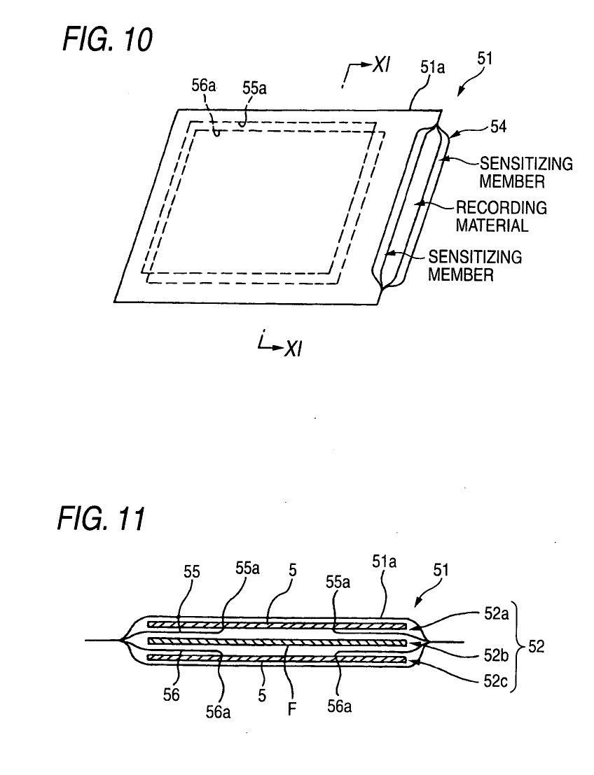

FIG. 10 is a perspective view to show a case of a photosensitive thermal development recording material of this embodiment. FIG. 11 is an XI-XI line cross-sectional view of the case of a photosensitive thermal development recording material illustrated in FIG. 10. As illustrated in FIGS. 10 and 11, a case 51 of this embodiment has a main body 51a and a housing section 52 provided inside the main body 51a. The main body 51a is a closed-end longitudinal bag-like member and constructed such that an opening 54 is formed in one end portion thereof and that the recording material F and the sensitizing member 5 can be inserted from this opening 54. The case 51 is a member in which at least the surface of the main body 51a is made of the foregoing light-shielding material.

The main body 51a of the case 51 of this embodiment is provided with two partitioning portions 55, 56 as integrally formed with the inner periphery of the housing section 52 so as to partition the housing section 52 into three spaces. The housing section 52 is partitioned into three pocket portions 52a, 52b, 52c by these portioning portions 55, 56.

Also, window portions 55a, 56a are formed in the portioning portions 55, 56, respectively. These window portions 55a, 56a each has a dimension corresponding to the type of the recording material F and the size and position of a latent image to be formed in the recording material F upon irradiation with X-rays.

In each of the outer two pocket portions 52a, 52C of the three pocket portions 52a, 52b, 52c, the sensitizing member 5 is housed, and in the inner pocket portion 52b, the recording material F is housed.

The case 51 of this embodiment houses the recording material F having a photosensitive layer on each of the surfaces thereof, and a latent image is distinctly formed upon irradiation with X-rays on each of these photosensitive layers by the sensitizing member 5 housed in each of the pocket portions 52a, 52c provided on the both surfaces of the recording material F.

Next, other embodiment of the photosensitive thermal development recording material according to the invention will be described below.

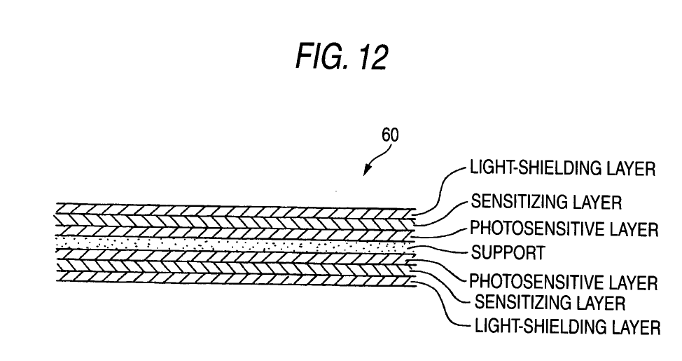

FIG. 12 is a cross-sectional view to show a case of a photosensitive thermal development recording material of this embodiment. As illustrated in FIG. 12, a photosensitive thermal development recording material 60 has a support 61, photosensitive layers 62 provided on the both surfaces of the support 61, and sensitizing layers 63 formed on the respective surfaces of these photosensitive layers 62.

Further, in the photosensitive thermal development recording material 60, the surfaces of the photosensitive layers 63 are each covered by a light-shielding layer 64.

Since this photosensitive thermal development recording material 60 is covered by the light-shielding layer 64, it can be handled in a bright room even in the state that it is not housed in a case made of a light-shielding material or a cassette of the related art. Accordingly, works in a dark room are not required, and therefore, such is convenient for use. Also, when X-ray capturing, it is possible to irradiate this photosensitive thermal development recording material 60 with X-rays; when thermal developing, by loading this recording material 60 in a thermal development equipment as it is, it is possible to perform thermal development processing; and after the thermal development, by peeling the light-shielding layers 64 and the sensitizing layers 63, it is possible to obtain the developed recording material 60.

Next, the production step of the photosensitive thermal development recording material illustrated in FIG. 12 will be described below.

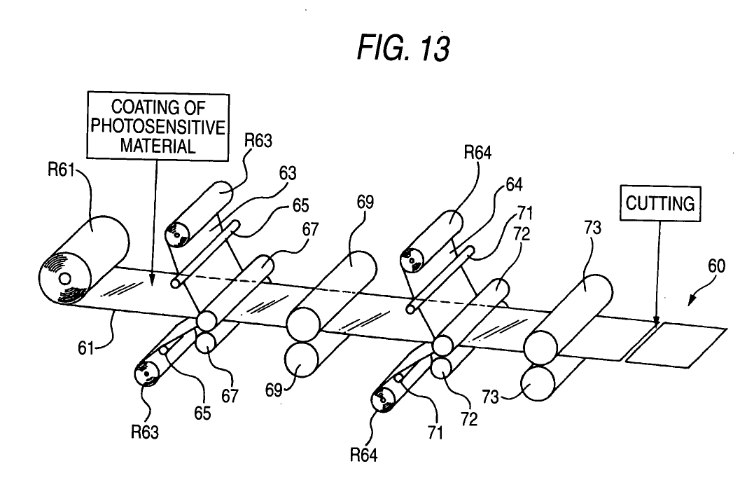

FIG. 13 is a view to conceptually explain the production step of the photosensitive thermal development recording material of FIG. 12. As illustrated in FIG. 13, the support 61 is wound out from a support master roll R61. Photosensitive materials are coated on the both surfaces of the support 61 wound out to form the photosensitive layer 62. Sensitizing material master rolls R63 are disposed in the upward and downward portions of a traveling passage of the support 61 having the photosensitive layers 62 formed thereon. Sensitizing materials (sensitizing layers 63) wound out from the sensitizing material master rolls R63 are pressed on the both surfaces of the support 61 by a pair of adsorbing rollers 67 while being guided by guide rollers 65 and heat sealed by a pair of heating pressure rollers 69 disposed in the downstream side in the traveling direction. Light-shielding material master rolls R64 are disposed in the upward and downward portions of the traveling passage of the support 61 in which the sensitizing layers 63 have been thus provided on the both front and rear surfaces thereof. Light-shielding materials (light-shielding layers 64) wound out from the light-shielding material master rolls R64 are pressed on the both surfaces of the support 61 by a pair of adsorbing rollers 72 while being guided by guide rollers 71 and heat sealed by a pair of heating pressure rollers 73 disposed in the downstream side in the traveling direction. The support 61 in which the light-shielding layers 64 have been provided on the both front and rear surfaces thereof is cut into a prescribed dimension in the downstream side of the heating pressure rollers 73 to prepare the recording material 60.

This product process of the recording material F includes a step for forming the photosensitive layer 62 on the support 61, a step for laminating the sensitizing layer 63 on the surface of the photosensitive layer 62, a step for laminating the light-shielding layer 64 on the surface of the sensitizing layer 63, and a step for cutting the support 61 in a single production step. Accordingly, it is possible to efficiently produce the photosensitive thermal development recording material 60 illustrated in FIG. 12, which can be handled in a bright room.

While the photosensitive thermal development recording material of the invention may be developed by any method, in general, an imagewise exposed photosensitive thermal development recording material is developed by raising the temperature. The development temperature is preferably from 80 to 250° C., and more preferably from 100 to 140° C.

The development time is preferably from 1 to 60 seconds, more preferably from 5 to 30 seconds, and especially preferably from 5 to 20 seconds.

As the thermal development mode, the plate heater mode is preferable. As the thermal development mode according to the plate heater mode, a method described in JP-A-11-133572 is preferable. This method is concerned with a thermal development equipment for bringing a photosensitive thermal development recording material having a latent image formed therein into contact with a heating unit to obtain a visible image, which is characterized in that the heating unit is composed of a plate heater; that plural press rollers are disposed opposing to each other along one surface of the plate heater; and that the photosensitive thermal development recording material is passed between the press roller and the plate heater to perform thermal development. It is preferable that the plate heater is divided into two to six stages and that the temperature of the tip portion thereof is lowered by from approximately 1 to 10° C.

Such a method is described in JP-A-54-30032. According to this method, it is possible to remove moisture or organic solvents contained in the photosensitive thermal development recording material out the system. Also, it is possible to suppress the change of the shape of the photosensitive thermal development recording material caused due to the matter that the photosensitive thermal development recording material is rapidly heated.

This application is based on Japanese Patent application JP 2004-060787, filed Mar. 4, 2004, the entire content of which is hereby incorporated by reference. This claim for priority benefit is being filed concurrently with the filing of this application.

1. A case for housing a photosensitive thermal development recording material, wherein
the material comprises:
a support; and
an image forming layer containing a photosensitive silver halide, a non-photosensitive organic silver salt, a reducing agent and a binder, and
the case comprises:
a main body so as to have a housing section for housing the material, the main body comprising a light-shielding material; and
a sensitizing member in the housing section.

2. The case according to claim 1, wherein the material comprises the image forming layer on at least one surface of the support.

3. The case according to claim 1, wherein the main body comprises the light-shielding material on a surface of the main body.

4. The case according to claim 3, wherein the light-shielding material covers the surface entirely.

5. The case according to claim 1, wherein the sensitizing member is adhered to an inner surface of the housing section and faces the image forming layer of the material.

6. The case according to claim 1, wherein the housing section comprises a partitioning portion to have a first pocket portion for housing the material and a second pocket portion for housing the sensitizing member, and
the partitioning portion comprises a window portion so as to form a latent image on the image forming layer at a portion corresponding to the window portion.

7. The case according to claim 1, wherein the light-shielding material cuts a color light having a wavelength of not longer than 500 nm.

8. A combination of a photosensitive thermal development recording material and a case for housing the material, wherein
the material comprises:
a support; and
an image forming layer containing a photosensitive silver halide, a non-photosensitive organic silver salt, a reducing agent and a binder, and
the case comprises:
a main body so as to have a housing section for housing the material, the main body comprising a light-shielding material; and
a sensitizing member in the housing section.

9. The combination according to claim 8, wherein the material comprises the image forming layer on at least one surface of the support.

10. The combination according to claim 8, wherein the main body comprises the light-shielding material on a surface of the main body.

11. The combination according to claim 10, wherein the light-shielding material covers the surface entirely.

12. The combination according to claim 8, wherein the sensitizing member is adhered to an inner surface of the housing section and faces the image forming layer of the material.

13. The combination according to claim 8, wherein the housing section comprises a partitioning portion to have a first pocket portion for housing the material and a second pocket portion for housing the sensitizing member, and
the partitioning portion comprises a window portion so as to form a latent image on the image forming layer at a portion corresponding to the window portion.

14. The combination according to claim 8, wherein the light-shielding material cuts a color light having a wavelength of not longer than 500 nm.

15. A combination of a case for housing a photosensitive thermal development recording material and a cassette for holding the case,
wherein the material comprises:
a support; and
an image forming layer containing a photosensitive silver halide, a non-photosensitive organic silver salt, a reducing agent and a binder,
the case comprises:
a main body so as to have a housing section for housing the material, the main body comprising a light-shielding material; and
a sensitizing member in the housing section; and
the cassette is capable of being loaded in an X-ray equipment for forming a latent image upon irradiation of the material with a X-ray.

16. A method for developing a photosensitive thermal development recording material,
the material comprising: a support; and an image forming layer containing a photosensitive silver halide, a non-photosensitive organic silver salt, a reducing agent and a binder,
wherein the method comprises:
housing the material in a case comprising a light-shielding material;
irradiating the material with a X-ray while a sensitizing member is kept in the case; and
thermal-developing the material while the material is housed in the case to develop a latent image.

17. A photosensitive thermal development recording material comprising:
a support;
an image forming layer containing a photosensitive silver halide, a non-photosensitive organic silver salt, a reducing agent and a binder;
a sensitizing layer; and
a light-shielding layer in this order.

18. The photosensitive thermal development recording material according to claim 17, wherein
the image forming layer is on at least one surface of the support;
the a sensitizing layer is on a surface of the image forming layer; and
a light-shielding layer is on a surface of the sensitizing layer.

19. A process for producing a photosensitive thermal development recording material,
the material comprising: a support; and an image forming layer containing a photosensitive silver halide, a non-photosensitive organic silver salt, a reducing agent and a binder,
wherein the process comprises:
forming the image forming layer on the support;
laminating a sensitizing layer on a surface of the image forming layer;
laminating a light-shielding layer on a surface of the sensitizing layer; and
cutting the support.
